(19) United States
(12) Patent Application Publication
(10) Pub. No.: US 2005/0043972 A1
(43) Pub. Date: Feb. 24, 2005

(54) System and method for reconciling an insurance payment with an insurance claim

(76) Inventors: Joyce L. Kossol, Belle Vernon, PA (US); Jon A. Webb, Pittsburgh, PA (US)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 10/837,111

(22) Filed: Apr. 30, 2004

Related U.S. Application Data
(60) Provisional application No. 60/466,953, filed on May 1, 2003.

(51) Int. Cl. G06F 17/60; H04K 1/00; H04L 9/00

(52) U.S. Cl. 705/4

(57) ABSTRACT

Disclosed herein is a method for reconciling an insurance payment to an entity, such as a pharmacy, with an insurance claim made by the entity. Some embodiments of the method comprise providing a claim value belonging to a set of claim values, providing a claim identification value associated with the claim value and belonging to a set of claim identification values, providing a payment value belonging to a set of payment values, providing a payment identification value associated with the payment value and belonging to a set of payment identification values and, where the payment identification value and the claim identification value correspond to each other, matching the payment value with the claim value. Additional systems and methods are also disclosed herein.

### CROSS-REFERENCE TO RELATED APPLICATIONS

The present application claims the benefit under 35 U.S.C. § 119(e) of U.S. Application No. 60/466,953 filed May 1, 2003, which is hereby incorporated by reference in its entirety for all purposes.

### BACKGROUND OF THE INVENTION

The invention disclosed herein relates generally to a system and method for reconciling insurance claims. More specifically, embodiments of the disclosed invention relate to a system and method for reconciling an insurance payment to a pharmacy with an insurance claim made by the pharmacy.

The thorough and efficient management of pharmacy-related information is a daunting task. Fortunately, however, computer-based pharmacy information-management systems (herein referenced as “PIMS”) provide independent and chain pharmacies with processes relating to inventory, transaction processing, checkout, pricing, accounts receivable, prescription processing and preferred shopping. Limited features are also available relating claim submission and third-party billing.

Moreover, some PIMS have functionality designed to manage information relating to the payment for a prescription or other good. Customers routinely make payment for only a portion of the prescription costs, such payments often being referred to as “co-payments.” However, other portions of the cost may be covered by one or more third-parties, such as a health insurer or other party. PIMS have the capability to accommodate this type of third-party billing. A pharmacy may utilize PIMS to submit claims directly to insurance companies. However, due to the large number of insurance companies associated with pharmacy customers, pharmacies routinely present claims to multiple insurance companies during each billing cycle. Examples of PIMS include Visual Pharmacy from Healthcare Computer Corporation and PRISM from Carolina Services.

Difficulties arise, however, in collecting payment from a given insurance company. It is the custom in the industry for an insurance company to present a pharmacy with a single payment (e.g. a single check) in collective satisfaction of all claims presented to the insurance company by the pharmacy during a given billing cycle. The single check payment is accompanied by an itemized document called a remittance document (also known as a remittance advice).

The remittance document itemizes the total payment into sub-payments, referenced herein as itemized amounts. Each itemized amount representing the amount being paid on a specific claim. Each itemized amount is listed together with information to identify the corresponding claim, such as the customer's name, social security number, or prescription number, for example. There is no per se uniformity between insurance companies as to the layout of the remittance document. Moreover, insurance companies do not routinely present pharmacies with electronic payment records.

Often times, the total amount does not accurately represent the sum of the itemized payments. Further, the document may be missing a payment or include an itemized payment that is being misdirected to the pharmacy. In some cases, an itemized payment may be less than or greater than the monetary amount that should be paid in response to a claim.

Some estimates place the loss to pharmacies at approximately $500 million per year due to errors on remittance documents. It has been difficult to minimize this loss, because the reconciliation of claim records and payment records has thus far required manual entry of payment information by clerical staff on a line-by-line basis. This presents a tremendous drain on the time, money, and resources of pharmacies, and in some cases it is cost-prohibitive preventing the reconciliation of claims and causing loss of income to a pharmacy. The nonpayment and underpayment of claims confers a benefit upon insurance companies, thereby removing an incentive for insurance companies to develop technologies to facilitate reconciliation.

The present invention addresses these and other deficiencies in the prior art. Among other things, the utilization of stand-alone insurance reconciliation software and/or PIMS-compatible insurance reconciliation software greatly increase the accuracy of records and accounting, facilitates the documentable recovery of funds, and enables pharmacies to better manage income, thereby improving net profits.

### SUMMARY OF THE INVENTION

As used herein, the following terms should be interpreted in accordance with the corresponding explanation of the term. For the purpose of nonlimiting example, the examples discussed herein relate to sample information taken from row 540 of sample remittance document 105 shown in FIG. 5.

A “Claim Record” comprises a record, preferably electronic, of a claim that is submitted by an entity to a third party for payment. A claim record at least includes a claim value and at least one claim identification value. The claim record is usually, but not necessarily, maintained by the entity in a database. The entity may be a pharmacy, medical practice, or any other entity that provides goods and/or services to a customer and/or patient and that receives at least partial payment by submitting a claim to a third party, such as an insurance company, for example.

A “Claim Value” is part of the claim record. The claim value comprises a data value representing the monetary amount of a claim. For example, when a claim is submitted by a pharmacy to an insurance company to get paid for a customer's prescription, the claim record of that submission includes a data value representative of the amount of that claim, such amount being for example, 58.55 USD, 84.49 CAD, and/or 7,000 Yen.

A “Claim Identification Value” is also part of the claim record. The claim identification value comprises a data item representing a piece of identifying information that is associated with a claim, such as the customer name, Rebecca Myers, or a prescription no. 12354, for example. Depending on the embodiment, there may be more than one field of identifying information and example fields include customer name, social security number, prescription number, etc, and sample data items in these fields may be Rebecca Myers, 12345, Apr. 16, 2003, etc. A claim identification value is preferably a value representative of one of these data items. A claim identification value is usually associated with a claim value (e.g. Rebecca Myers is associated with the claim for $58.55 in FIG. 5). More than one claim identification value may be associated with a claim value (e.g. Rebecca Myers, prescription fill date Apr. 16, 2003, and prescription number 12354 are all associated with $58.55 in FIG. 5).

An “Itemized Payment” comprises the monetary amount of payment on a claim as actually shown by a document, such as the remittance document. For example, as shown in row 540 of the sample remittance document 105 of FIG. 5, the itemized payment is $58.55. An itemized payment is distinguished below from a “payment value.” A “payment value” refers to a data value representative of the monetary payment amount. However, the “itemized payment” refers to the payment amount as actually shown on a remittance document, for example.

An “Itemized Identification” relates to the information as actually shown by a document, such as the remittance document. For example, as shown in row 540 of sample remittance document 105 of FIG. 5, the first itemized identification is prescription 12345, a second itemized identification is Rebecca Myers, a third itemized identification is Apr. 16, 2003, etc. An itemized identification is distinguished below from a “payment identification value.” A “payment identification value” refers to a data value representative of an identifying piece of information. However, the “itemized identification” refers to that identifying piece of information as it is shown on a remittance document, for example.

A “Payment Record” comprises a record, preferably electronic, of a payment from a third party that is received by an entity. A payment record usually comprises a payment value and at least one payment identification value. Depending upon the embodiment, the payment record is usually, but not necessarily, created by processing an itemized payment and itemized identification into a payment value and payment identification value(s). The association between the itemized payment and itemized identification is preferably preserved between the payment value and the at least one payment identification value.

A “Payment Value” is part of an electronic payment record. A payment value comprises a data value representing the monetary amount of a payment for a claim (e.g. $58.55). Depending upon the embodiment, optical character recognition and/or other technologies are used to process the itemized payment into the payment value.

A “Payment Identification Value” is also part of an electronic payment record. A payment identification value comprises a data value representing a piece of identifying information (e.g. representing “Rebecca Myers”). Depending upon the embodiment, optical character recognition and/or other technologies are used to process the itemized identification into the payment identification value. A payment record may comprise more than one payment identification value (e.g. representing Rebecca Myers, Apr. 16, 200, etc.).

“Unpaid claim records” generally refer to claim records that are yet unpaid and//or have yet to be successfully matched with a payment record. “Reconciled claim records” generally refer to claim records that have been successfully matched with a payment record and include the payment record information.

An “Anomalous Payment” refers, for example, to the case where there is no payment record to match a claim record (and/or vice versa). This may happen due to human and/or machine error as described herein, for example, or it may be because the total paid amount fails to include payment for a particular claim. As another example, an anomalous payment also refers to the case where there in no claim record to match a payment records. This may happen due to human and/or machine error as described herein, for example, or it may be because the total amount on the remittance document includes payment for a claim that was not submitted by the entity.

A system and method is disclosed herein for reconciling an insurance payment to an entity, such as a pharmacy, with an insurance claim made by the entity (or on behalf of the entity). Embodiments of the system include a computer-readable medium having stored thereon computer-executable instructions for performing the methods herein described. Any suitable computer-readable medium may be used, including for example and without limitation, electromagnetic and/or optical storage media, “hard” drives, at least temporary memories, etc. Any suitable portable and/or non-portable medium may be used. The computer-readable medium may be distributed.

The system and method preferably includes providing a claim value belonging to a set of claim values, providing a claim identification value associated with the claim value and belonging to a set of claim identification values, providing a payment value belonging to a set of payment values, and providing a payment identification value associated with the payment value and belonging to a set of payment identification values.

The system and method preferably includes matching the payment value with the claim value if the payment identification value and the claim identification value correspond to each other. In some aspects where there is a match, the system and method includes comparing the payment value and the claim value to identify at least one of underpayment, overpayment, and accurate payment.

The claim identification value and payment identification values each preferably include a data item representative of at least one of a pharmacy customer, a prescription number, a date, a price code, a sale number, a social security number and a sale quantity. In some aspects, the reconciliation method corresponds the payment identification value and the claim identification with each other, when the payment data item and the data item are the same or similar. Further, an anomalous payment may be indicated where the payment value is unmatched with all members of the set of claim values. Also, where the claim value is unmatched with each member of the set of payment values, a missing payment is indicated.

In some aspects, the system and method include forming a filter expression from a scan of the remittance document. This is done in order to facilitate matching. The document associates an itemized payment with an itemized identification by listing them next to each other in the same row, for example. The association between the payment value and the payment identification value are defined based at least in part on the association between the itemized payment and the itemized identification shown in the document. Definition can occur during the translation of the payment amount from a written visual representation to a data representation.

Another association may also be defined between another payment value and another payment identification value, the association being defined at least in part on an association between another itemized payment and another itemized identification. In this respect, the method is adapted to process multiple claim records and multiple payment records. Further, some aspects of the method comprise verifying one or more of a match, an anomalous payment, an underpayment, an overpayment and an accurate payment. An anomalous payment includes, for example, a missing payment or a misdirected payment. An emulation of the remittance document is preferably provided by the reconciliation modules and has a layout substantially similar to the layout of the remittance document. The emulation facilitates editing and subsequent re-matching.

In some aspects, the reconciliation method imports the claim value and/or the claim identification value from an external application, while maintaining the association between the claim value and the second identification value. Further, the payment value may be exported to the external application, while maintaining the association between the payment value and at least one of the first and second identification values. In some aspects, this may comprise posting the payment value.

In some aspects, the reconciliation method receives the claim value and/or the claim identification value from a database, while maintaining the association between the claim value and the second identification value. Further, the payment value may be sent to the database, while maintaining the association between the payment value and at least one of the first and second identification values. In some aspects this may comprise posting the payment.

Also disclosed herein is another embodiment of a system and method for reconciling an insurance payment to a pharmacy with an insurance claim made by the pharmacy. The system and method includes providing a claim value belonging to a set of claim values, providing a claim identification value associated with the claim value and belonging to a set of claim identification values, and scanning a document that articulates itemized payments and itemized identifications and associates an itemized payment with an itemized identification. An association between a payment value and a payment identification value, based at least in part on the association between the itemized payment and the itemized identification. The payment value and the payment identification value are then provided.

Where the payment identification value and the claim identification value correspond to each other, the reconciliation method matches the payment value with the claim value. Further, where the payment value and the claim value are matched, the method compares the payment value and the claim value to identify an underpayment, overpayment, and/or accurate payment. Where a payment value and/or a claim value is unmatched, the method indicates a misdirected payment or a missing payment, respectively.

Also disclosed herein is a system for reconciling an insurance payment to a pharmacy with an insurance claim made by the pharmacy, comprising a computer-readable medium having stored thereon computer-executable instructions for performing the following: providing a claim value belonging to a set of claim values; providing a claim identification value associated with the claim value and belonging to a set of claim identification values; providing a payment value belonging to a set of payment values; providing a payment identification value associated with the payment value and belonging to a set of payment identification values; and if the payment identification value and the claim identification value correspond to each other, matching the payment value with the claim value. In some aspects, if the payment value and the claim value are matched, comparing the payment value and the claim value to identify at least one of underpayment, overpayment, and accurate payment.

In some aspects, the instructions are executable so that, if the payment value is unmatched with each member of the set of claim values, an anomalous payment is to be indicated. If the claim value is unmatched with each member of the set of payment values, the instructions may alternatively or additionally be executable to indicate a missing payment. In some aspects, the instructions are executable to form a filter expression from a scan of an itemized remittance document to facilitate matching and/or to scan a document, such as an itemized remittance document for example. The remittance document displays itemized payments and itemized identifications in such a manner so there is a visual association between the itemized payment and the itemized identification (such as by listing or grouping them next to each other, for example). In some embodiments, the system comprises a scanner.

The instructions also define the association between the payment value and the payment identification value, basing the definition on the association between the itemized payment and the itemized identification. In some aspects, the instructions may additionally define an association between another member of the set of payment values and another member of the set of payment identification values, based on an association between another itemized payment and another itemized identification. In some aspects, the instructions are executable to verify an anomalous payment, an underpayment, an overpayment and/or an accurate payment.

Some embodiments of the system comprise a printer, and in some aspects, the instructions are executable to provide an emulation of the remittance document, such as the itemized remittance document. The emulation preferably has a layout substantially similar to the remittance document, for example, and facilitates editing and re-matching.

In some aspects, claim identification value and the payment identification value each comprises a data item representative of a pharmacy customer, a prescription number, a date, a price code, a sale number, a social security number and/or a sale quantity. The instructions are executable to correspond the payment identification value and the claim identification with each other when the payment data item and the data item are the same or similar.

The instructions are executable to import the claim value and/or the claim identification value from an external application, while maintaining the association between the claim value and the claim identification value. Further, the instructions are also executable to export the payment value to the external application, while maintaining the association between the payment value and at least one of claim and payment identification values. In some aspects, exporting includes posting the payment value to the external application. Some embodiments of the system include the external application.

In some aspects, the system instructions are executable so that the reconciliation modules receive the claim value and/or the claim identification value from a database, while maintaining the association between the claim value and the second identification value. Furthermore, the payment value may be sent to the same or another database, while maintaining the association between the payment value and at least one of the first and second identification values. This may include the posting of data. Some embodiments of the system comprise a processor for executing the instructions and/or a database.

Also disclosed herein is a method for reconciling insurance payments with insurance claims. The method includes receiving a plurality of unpaid claim records, creating a plurality of payment records from a scanned remittance document, matching at least one of the plurality of unpaid claim records with a corresponding one of the plurality of payment records to form a matched pair, and comparing the at least one unpaid claim record against the corresponding one of the payment records to identify one of an underpayment, an overpayment, and an accurate payment.

In some aspects, the method comprises verifying the accuracy of the matched pair and/or verifying the accuracy of the payment values and/or payment identification values. Some aspects may include indicating an underpayment, overpayment or accurate payment. Moreover, some embodiments of the method include the actual scanning of the remittance document.

In some aspects, the plurality of unpaid claim records are received from an external application. In some embodiments, however, the plurality of unpaid claim records are imported from an external application and the plurality of reconciled claim records are exported to the external application. Alternatively and/or additionally, the unpaid claim records may originate from a database and the reconciled claim records are sent to the database.

These and other features and objects of the invention will be more fully understood from the following detailed description of the preferred embodiments, which should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention. In the drawings:

FIG. 1 is a schematic diagram showing an embodiment of the reconciliation modules;

FIG. 2 is a schematic diagram showing another embodiment of the reconciliation modules shown in FIG. 1;

FIG. 3 is a schematic diagram showing yet another embodiment of the reconciliation modules shown in FIG. 1;

FIG. 4 is a flow chart showing an embodiment of the matching module shown in FIGS. 1-3;

FIG. 5 is an illustration showing an embodiment of a remittance document;

FIG. 6a is an illustration showing an embodiment of a master interface;

FIG. 6b is an illustration showing an embodiment of a scanning interface;

FIG. 6c is an illustration showing an embodiment of an emulation of the remittance document shown in FIG. 5; and

FIG. 7 is an illustration showing an embodiment of a verification interface.

### DETAILED DESCRIPTION OF THE INVENTION

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose.

Disclosed herein is a software-related system and method with a foundation in the optical scanning of original pages of data from an itemized remittance document. In most cases, the remittance document is supplied by a third-party insurance company that is submitting payment to a pharmacy. Reconciliation modules facilitate transfer of data into electronic format, which can then be inputted, exported, and/or posted to an accounts receivable database. In the preferred embodiments, the database is part of a PIMS application external to the invention. In some embodiments, the reconciliation modules are part of an integrated PIMS or other integrated software.

In some aspects, the reconciliation modules enable a pharmacy or other entity to automatically scan and post data. The reconciliation modules convert printed data into electronic format and facilitate posting of payments from third party insurance companies directly into the PIMS accounts receivable database. The reconciliation modules identify accurate payments, underpayments, overpayments, and anomalous payments. An anomalous payment comprises, for example, a missing payment or a payment that was inadvertently misdirected to the pharmacy.

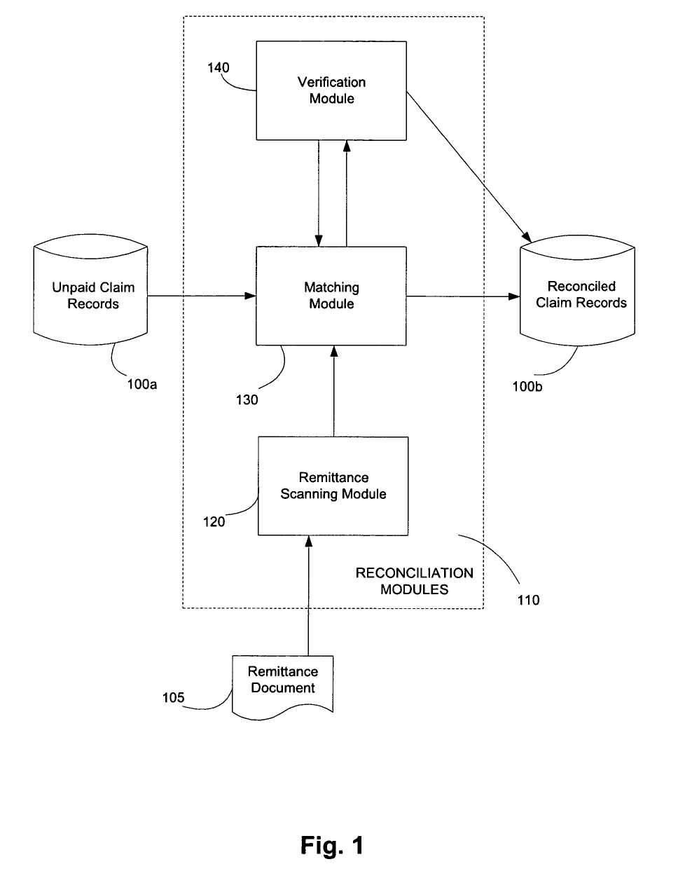

Referring to FIG. 1, one of the preferred embodiments of the reconciliation modules is shown. The reconciliation modules are designated generally 110 and preferably comprise a remittance scanning module 120, a matching module 130, and a verification module 140. In some embodiments, the origin of unpaid claim records and the destination of reconciled claim records are the same location, database, application, module, etc.

Claim records preferably originate from a computer-readable medium where they are at least temporarily stored. In one of the preferred embodiments, claim records originate from a database 100a, resident on a computer and/or computer network. All modular components discussed herein may be in a distributed and/or networked environment. Claim records may be perceived on a computer system with a display or other output device such as a printer, for example. In some embodiments, the system includes a processor and/or other electronic controller. Databases discussed herein, preferably comprise relational databases. However, suitable hierarchical and/or object-oriented databases may be also be used. Database 100a and database 100b are preferably the same database. However, as shown, database 100a and database 100b are not necessarily the same database.

Database 100a comprises a plurality of claim records that are initially flagged as unpaid claim records. For illustration and without limitation, consider the example where a pharmacy database contains a series of electronic records of claims that the pharmacy has submitted to a health insurer for payment. In this example, each claim record at least comprises a claim value representative of the monetary amount of the claim. Continuing with the example, each claim record also contains some piece of identifying indicia such as, for example the customer's name in which the claim is being submitted. Alternatively or additionally, the identifying indicia include a prescription number, a date, a price code, a sale number, a sale quantity, a social security number, or other suitable indicia. Thus, in addition to a claim value representative of the monetary amount of a claim, the record also includes at least one associated claim identification value representative of a data item from one of many identification fields.

Database 100a may have, but does not necessarily have, records additional to unpaid claim records. However, it is preferable that only required that unpaid claim records get forwarded to reconciliation modules 110. Database 100a comprises a set of these unpaid claim records, each claim record including a claim value and at least one associated claim identification value. The preferred embodiment of the system and method is capable of processing multiple claim records. The claim value thus belongs to a set of claim values and the claim identification value belongs to a set of claim identification values. While each set preferably comprises a plurality of members, the term “set” is used herein to refer to group that comprises at least one member.

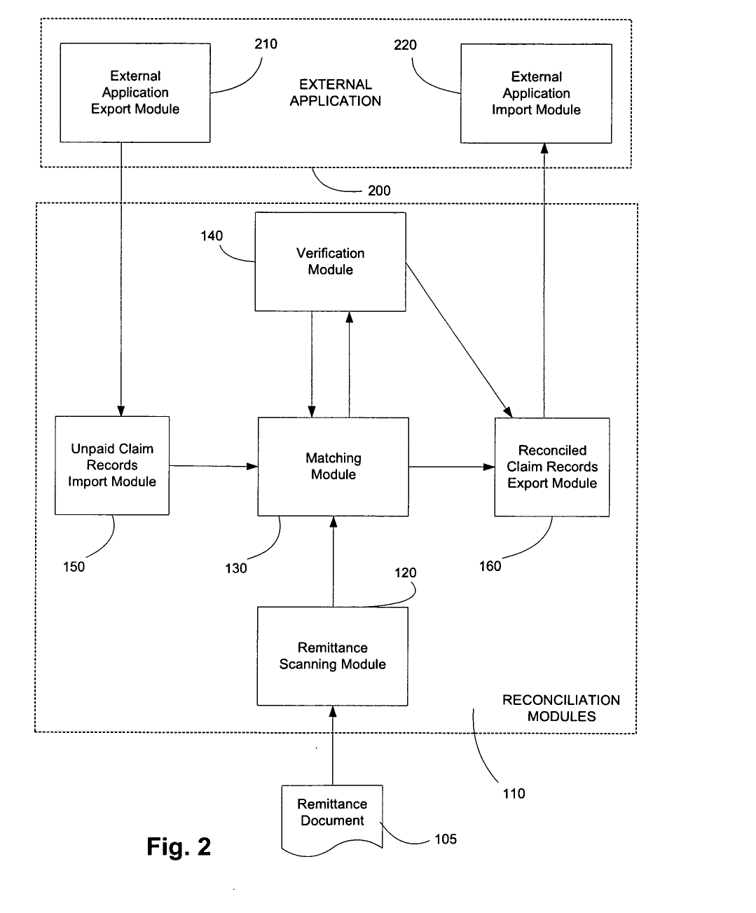

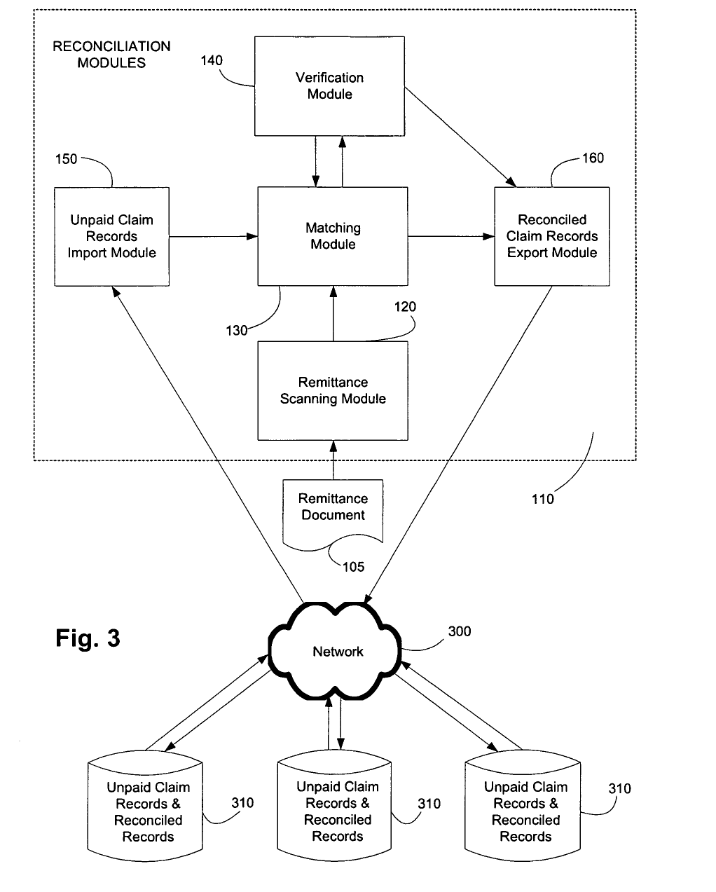

Claim records are supplied from database 100a to the reconciliation modules 110 for reconciliation with payment records provided by remittance scanning module 120. In one of the preferred embodiments, claim records are provided directly to matching module 130 for matching with payment records. In some embodiments, claim records may be imported into reconciliation modules 110 from an external application 200 or networked database 100. However, external application 200 and networked databases 100 will be further discussed below with references to FIGS. 2 and 3, respectively.

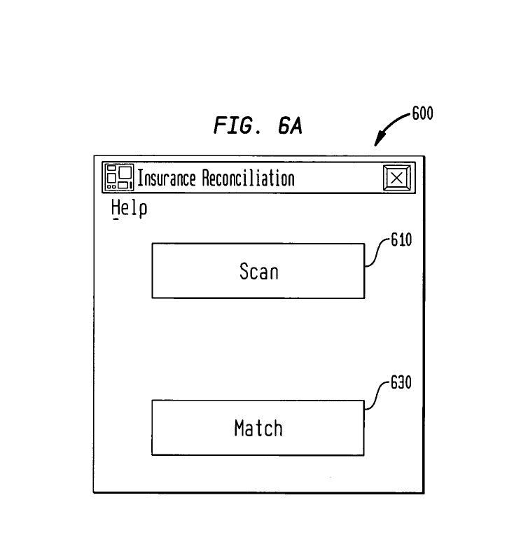

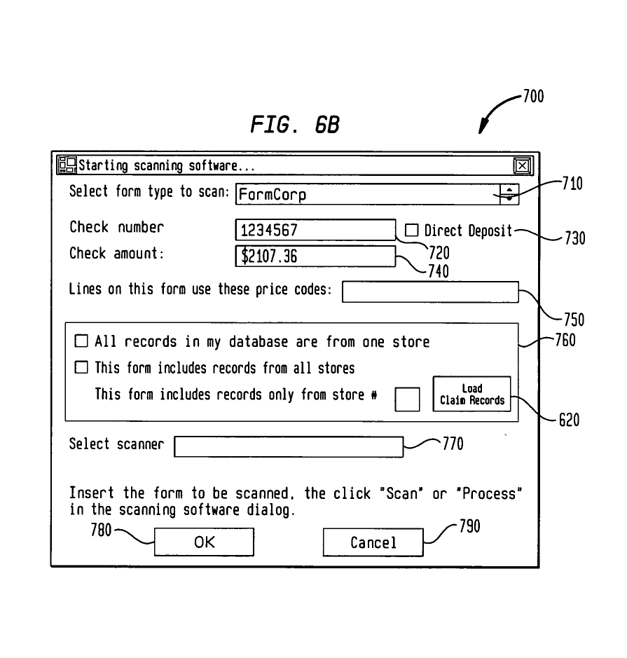

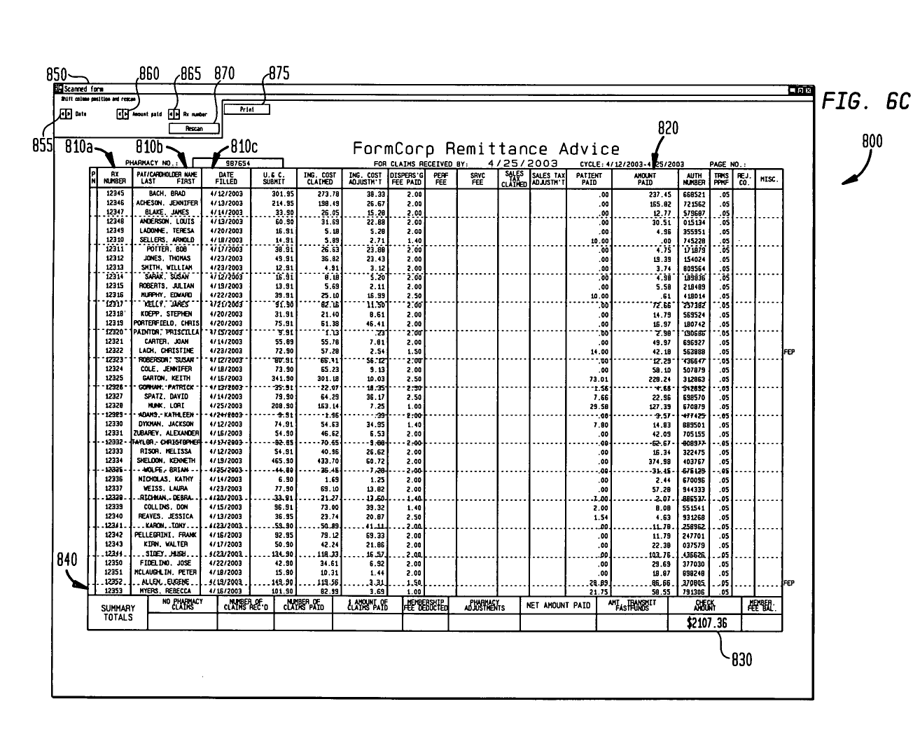

Remittance scanning module 120 facilitates the scanning of remittance document 105 and processes the scanned information into payment records, each payment record preferably comprising a payment value and at least one payment identification value associated therewith. The association between itemized payments and itemized identification is specific from one type of form to another (e.g. forms for different insurance companies) and will be discussed further below with reference to FIG. 6c. The remittance document is preferably scanned at the initiation of a user.

Scanning methods are generally known in the art and, for the purposes of nonlimiting example, reference is made to Special Issue on Optical Character Recognition, Proceedings of the IEEE, Vol. 80 No. 7 (July 1992), the contents of which are herein incorporated by reference. Specific nonlimiting reference from these proceedings is made to J. Schürmann, et al., Document Analysis—From Pixels to Contents, Proceedings of the IEEE, Vol. 80 No. 7, pp. 1101-19 (July 1992) and S. Tsujimoto and H. Asada, Major Components of a Complete Text Reading System, Proceedings of the IEEE, Vol. 80 No. 7, pp. 1133-49 (July 1992), the contents of which are herein incorporated by reference.

Nonlimiting reference is also made to the following publications, the contents of which are herein incorporated by reference: J. H. Shumillian, H. S. Baird, T. L. Wood, A Retargetable Table Reader, Fourth International Conference on Document Image Analysis, pp. 158-163 (Aug. 18-20, 1997 Ulm, Germany); Datapro (Gartner Group), Detran, N.J., July 1998; Imaging systems, Input Technologies and Products, Section 6 (July 1992); J. Mao, R. Lorie, K. Mohiddun, A System for Automatically Reading IATA Flight Coupons, Fourth International Conference on Document Image Analysis, pp. 153-157 (Aug. 18-20, 1997 Ulm, Germany); R. B. Hennig, The IBM 1925 Optical Page Reader, Parts I-III, IBM Journal of Research and Development, Vol. 12 No. 5, pp. 346-371; and S. Mori, C. Y. Suen, K. Yamamoto, Historical Review of OCR Research and Development, Document Image Analysis (IEEE Computer Society Press, Los Alamitos, Calif. 1995). Nonlimiting reference is further made to the following patents, the contents of which are herein incorporated by reference: U.S. Pat. No. 6,546,385 (Mao et al. Apr. 8, 2003); U.S. Pat. No. 6,512,848 (Wang et al. Jan. 28, 2003); U.S. Pat. No. 6,097,834 (Krouse et al. Aug. 1, 2000); U.S. Pat. No. 6,094,505 (Lech et al. Jul. 25, 2000); U.S. Pat. No. 5,768,416 (Lech et al. Jun. 16, 1998); U.S. Pat. No. 5,625,465 (Lech et al. Apr. 29, 1997); and U.S. Pat. No. 5,369,508 (Lech et al. Nov. 29, 1994).

Remittance scanning module 120 processes the scanned records into meaningful payment records, preferably of an electronic format. In some embodiments, remittance scanning module 120 defines an association between the payment value and the payment identification value, based at least in part on the association between the itemized payment and the itemized identification as indicated by remittance document 105. In the preferred embodiment, remittance scanning module 120 utilizes the ABBYY FineReader Engine 6.0, manufactured by ABBYY Software House of Moscow, Russia.

Remittance scanning module 120 provides the payment values and associated payment identification values to matching module 130. Remittance scanning module 120 ascertains the identity of the applicable payment identification field (e.g. customer name, prescription number, etc.) by utilizing optical character recognition (OCR), for example. In some embodiments, the applicable payment identification field is predefined and/or dynamically defined by a user.

Matching module 130 attempts to match the payment records with the claim records. In a preferred embodiment, matching module 130 forms a filter expression from the scan of remittance document 105. The filter expression is preferably based on a relational database query used to access a Microsoft® ADO.NET DataSet. The filter expression used to query the table is formed from the scanned record by preferably incorporating the payment identification values for prescription number, date, price code, and sale quantity. In some embodiments, the filter expression is formed from a single payment identification value.

Matching module 130 matches payment values to claim values by corresponding the payment identification value associated with the payment value to the claim identification value associated with the claim value. If a payment identification value and a claim identification value correspond to each other, the payment value is matched with the claim value and forwarded to verification module 140 or database 100b, for example. A payment identification value and claim identification value “correspond” to each other when they both represent the same field, such as a name, and when they both represent the same data item in that field, such as Rebecca Meyers, for example.

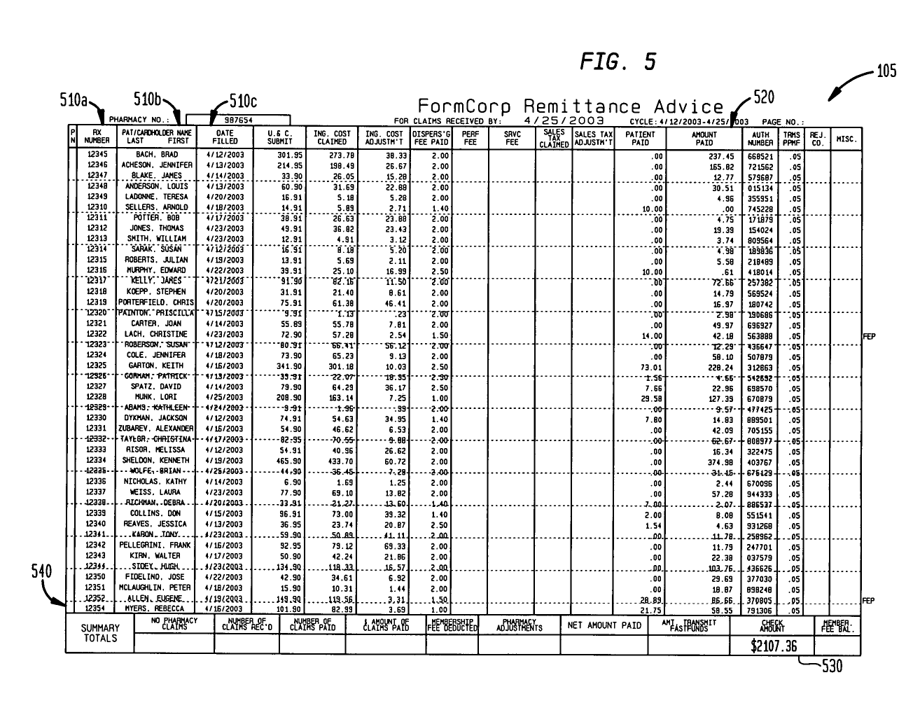

A payment identification value and claim identification value also “correspond” to each other when they both represent a different field, such as a name and prescription number, but they each represent data items that correspond, such as Rebecca Meyers and prescription number 12354, respectively (e.g. FIG. 5). Thus, some embodiments of matching module 130 will match a claim identification value representative of a data item from a first field with a payment identification value representative of a data item from a second field, so long as the identification values correspond to each other. For further nonlimiting illustration, a $58.55 claim value identified by a claim identification value for 12354 (where the field is prescription number) can be successfully matched with a payment value identified only by the payment identification value for Rebecca Myers (where the field is customer name), so long as prescription number 12354 corresponds to Rebecca Myers, which it does as shown in the last line of FIG. 5. Should the claim identification value correspond to many other customer names, such as the case when the identification value contains a data item from the date field (e.g. Apr. 24, 2003), then the user will have an opportunity to correct the information by utilizing verification module 140.

If a match for a payment identification value is not found, matching module 130 uses an iterative, recursive, or other process to make comparisons between the payment identification value and other members in the set of claim identification values until a match is found and the matching pair of claim record/payment record can be forwarded to verification module 140 or database 100b. A failure to make a match between a payment identification value and a claim identification value indicates an anomalous payment. An anomalous payment may indicate that the insurance company included an itemized payment in its total payment for a customer or prescription that is not served by the pharmacy or did not purchase a prescription during the billing cycle. An anomalous payment could also indicate a data entry error or that an error occurred in remittance scanning module 120. As discussed further below, some embodiments of verification module 140 facilitate the discovery of such error.

Matching module 130 preferably identifies claims for which there is no payment by identifying claim identification values that do not correspond with any payment identification values. If a match for a claim identification value is not found, matching module 130 indicates an anomalous payment. An anomalous payment may indicate that the insurance company did not include payment for a customer or prescription as part of the total payment. An anomalous payment may also indicate data entry error or scanning error. Again, some embodiments of verification module 140 facilitate the discovery of such errors.

Preferably after discovering an anomalous payment, some embodiments of matching module 130 will then compare the payment value and the claim value to identify whether there has been an underpayment, overpayment, or an accurate payment. A user also has an opportunity to utilize verification module 140 to verify, and correct if necessary, the accuracy of any indicated underpayment or overpayment. However, in embodiments where a comparison is made, matching module 130 sends a matched accurate claim record to database 100b, however it may be alternatively forwarded to verification module 140 for further confirmation of the accuracy of the reconciled record. In embodiments that indicate underpayments or overpayments, the underpayment and/or overpayment record is automatically forwarded to verification module 140. Comparing claim and payment amounts to ascertain an underpayment or an overpayment is particularly useful in embodiments of the invention directed towards a medical or dental practice. The provision of medical and dental services usually involves relatively high claim and payment values, where a discrepancy in payment amount has the potential to be quite substantial.

Verification module 140 preferably communicates all unmatched records to the user. In embodiments where a comparison is made between claim values and corresponding payment values, the verification module additionally communicates overpayments, and underpayments to the user. Verification module 140 also allows the user to edit any data items that were rendered inaccurate by remittance scanning module 120, matching module 130, and/or by other error. Verification and editing assist in the prevention of corrupting database 100b. Once a claim record or payment record is edited, either a reconciled claim record is forwarded to database 100b or an unpaid claim record is sent back to matching module 130 for re-matching (e.g. another attempt at matching).

Should re-matching be unsuccessful, the edited claim record and/or payment record is once again returned to verification module 140. A user has an opportunity to further edit the claim record and/or payment record and may choose to return the record once again to matching module 140 for another attempt at re-matching. Alternatively, the record may be flagged and is preferably not forwarded to database 100b, so as to prevent database corruption.

In the case of information is determined to be accurate after it is edited, verification module 140 sends a reconciled claim record to database 100b. The reconciled claim record preferably comprises the payment value, the claim value, as well as at least one claim or payment identification value. During this process, the association is maintained between the payment and/or claim value and the associated identification information.

Referring to FIG. 2, another preferred embodiment of reconciliation modules 110 is shown. As shown, some embodiments of reconciliation modules 110 are adapted to interface with an external application 200. Reconciliation modules 110 include a claim records import module 150 for importing claim records, including claim values and associated claim identification values from external application 200. Reconciliation modules 110 also comprises a reconciled claim records export module 160 for exporting and/or posting reconciled claim records to external application 200.

External application 200 preferably comprises a PIMS. For example and without limitation, QS/1® Data Systems produces a PIMS that is compatible with reconciliation modules 110. In some embodiments, import module 150 and export module 160 are designed so that reconciliation modules 110 are modular, being simultaneously compatible with many different PIMS. External application 200 comprises external export module 210 and external import module 220. External export module 210 and claim records import module 150 are designed to interface with each other, and reconciliation records export module 160 and external import module 220 are designed to interface with one another. The import/export standards are usually, but not necessarily, defined by the given PIMS. For example without limitation, the QS/1® PIMS defines both the method of posting as well as the file format used for posting.

Referring to FIG. 3, another preferred embodiment of reconciliation modules 110 is shown. A computing system (not shown), comprises reconciliation modules 110 and suitable hardware, such as for example, a server, processor, at least temporary memory, scanner, communications device, display, input device, etc. Reconciliation modules import and export data through a network 300 to a plurality of databases 310. Each database 310 is resident on a remote computer system across network 300. For example, the reconciliation modules 110 are located on a computer system at a centralized facility, and each database 310 is located on a computer system at any number of pharmacies, medical practices, dental practices, etc. Databases 310 and reconciliation modules 110 preferably communicate via a virtual private network (VPN), however any suitable means for communication may be utilized. Import Module 150 is adapted to receive claim records information over network 300 and export module 160 is adapted to send information over network 300.

Claim records are sent from one of database 310 and, after they are reconciled with payment records, the reconciled claim record is preferably sent back to that same database 310. An external application, resident on each remote computer, preferably provides the claim records to network 300 and reconciliation modules 110. The external application also receives the reconciled claim records from reconciliation modules 110 through network 300.

Payment records are preferably created by scanning remittance document 105 at the centralized facility. The central facility matches these payment records against the claim records downloaded from the remote sites and then uploads the reconciled claim records to the remote sites. In some embodiments, remittance documents may be scanned at the remote location and then electronically transmitted to reconciliation modules 110 at the central computing system. However, this may require additional software to be installed at the remote sites, and in some cases, may require portions of reconciliation modules 110 to be distributed.

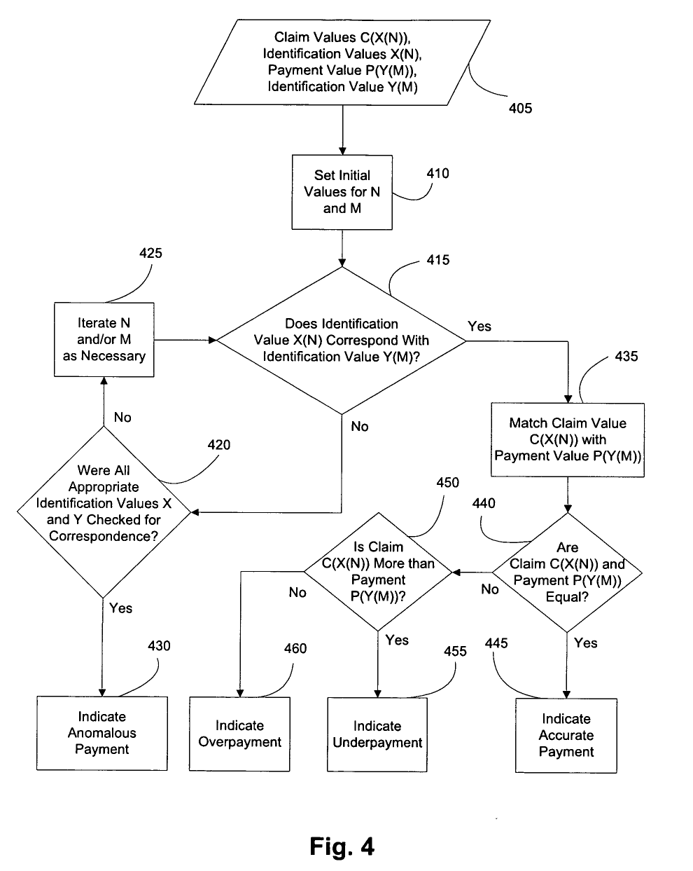

Referring to FIG. 4, an embodiment of the matching module 130 will now be further discussed in detail. One skilled in the art will appreciate that the flow of the steps of FIG. 4 are interchangeable in places. Such permutations are contemplated by the invention and the embodiment of FIG. 4 is for the purpose of illustration and not limitation. The preferred embodiment includes Steps 400-435. Some embodiments further include Steps 440-460.

At Step 405, data is received at matching module 130. The values N and M are used as counters to indicate what claim record and payment record, respectively, are being worked with. N identifies a claim record received from database 100a or from claim records import module 15. M identifies a payment record received from remittance scanning module 120. Claim identification values are associated with the claim records and are thus represented as X(N), and associated claim values are represented as C(X(N)). Payment identification values are associated with the payment records and are thus represented as Y(M), and associated payment values are represented as P(Y(M)). To the extent necessary, initial values are set for N and M at Step 410

At Step 415, claim identification value X(N) is checked for correspondence with payment identification value Y(M). As discussed above, claim identification values and payment identification values need not be equal to correspond, however they must at least relate to each other (e.g. both be associated with the same claim value and/or same payment value). If the claim identification value and payment identification value correspond to each other then claim value C(X(N)) and payment value P(Y(M)) are matched at Step 435, which is further discussed below.

If the identification values do not match, then at Step 420, matching module 130 determines if there are other payment identification values to be compared to claim identification values and/or vice versa. To the extent all possible comparisons have been made, then at Step 430, matching module 130 indicates an anomalous payment to verification module 140. An anomalous payment may comprise a missing payment, a misdirected payment, a scanning error, a data entry error, etc. If however, all comparisons have not been made, then at Step 425, N and/or M are iterated accordingly. Depending on the embodiment, Step 425 may additionally or alternatively comprise recursive deduction or another suitable means for facilitating comparison. The new identification value(s) associated with the new records are then compared again, and Steps 415, 420, and 425 are repeated until a match is made or matching is unsuccessful.

As stated above, once the identification values correspond to each other, then claim value C(X(N)) and payment value P(Y(M)) are matched at Step 435. After matching, some embodiments of matching module 130 make comparisons to ascertain an accurate payment, an underpayment, or an overpayment. Continuing with reference to embodiments that make this comparison, a comparison is made between claim value C(X(N)) and payment value P(Y(M)) to ascertain equality at Step 440. If the values are not equal, then matching module 130 proceeds to comparison Step 450. However, if the values are equal then, at Step 445, matching module 130 indicates an accurate payment and forwards the record for export or to a database. If any records remain, N and/or M are iterated or otherwise varied accordingly, and the method returns to matching Step 415 (not shown).

Continuing with reference to embodiments that compare claim values and payment values, a comparison is made between claim value C(X(N)) and payment value P(Y(M)) to ascertain whether C(X(N)) is greater than P(Y(M)) at Step 450. If claim value C(X(N)) is not greater then payment value P(Y(M)), matching module 130 proceeds to Step 460. However, if claim value C(X(N)) is greater than payment value P(Y(M)), then at Step 455, matching module 130 indicates an underpayment and forwards the record to verification module 140. If any records remain, N and/or M are iterated or otherwise varied accordingly, and the method returns to matching Step 415 (not shown).

If an accurate or underpayment do not apply to the comparison, the matching module 130 indicates an overpayment at Step 460 and forwards the record to verification module 140. If any records remain, N and/or M are iterated or otherwise varied accordingly, and the method returns to matching Step 415 (not shown).

The above-described method of matching module 130 is repeated until all records have been reconciled or forwarded to verification module 140. If records are forwarded to matching module 130 from verification module 140, then re-matching is performed in a manner similar to the matching process.

With reference to FIGS. 5-7, the creation of payment records will now be discussed in further detail.

Referring to FIG. 5, an embodiment of remittance document 105 is shown. Remittance document 105 articulates a plurality of itemized payment and itemized identifications and also associates each itemized payments with at least one itemized identification. For example without limitation, remittance document 105 shows a list of itemized monetary amounts 520 and lists of itemized identifications such as prescription numbers 510a, customer names 510b, and prescription fill dates 510c. Consider the example of Rebecca Myers in row 540. $58.55 is an itemized payment associated with the itemized identification, Rebecca Myers is $58.55. The $58.55 claim amount is also associated with itemized identification 12354 (prescription number) and itemized identification Apr. 16, 2003 (prescription fill date).

Remittance document 105 also contains other information that may be scanned for creation of records. Depending upon the embodiment, this includes the pharmacy code or billing cycle dates, for example. Other scannable information on remittance document 105 includes the U & C (Usual and Customary) Claim Amount, Ingredient Costs Claim, Ingredient Cost Adjustments, Disbursing Fees Paid, Performance Fee, Service Fee, Sales Tax as Claimed, Sales Tax Adjustment, Patient Paid Amount, Authorization Number and other information such as for example, the number of pharmacy claims received and the number of pharmacy claims paid. The remittance document may also list the check amount in check amount box 530. Any and all of these pieces of information, including the check amount, for example may be scanned and processed into a data item for electronic processing.

Referring principally to FIGS. 6a and 6b, an embodiment of a master user-operable interface is shown and designated generally as 600. Master interface 600 allows a user to initiate the various steps of reconciliation modules 110. A user first initiates scanning and the creation of payment records by pressing scan button 610. Pressing claim records button 620 initiates the importation or other receiving of claim records. Depending upon the embodiment, claim records will be received from an associated database 100a, an external application 200, and/or a networked database 310. Pressing the match button 630 initiates the process of matching claim records against payment records, and in some embodiments, the comparison of claim values against payment values. The steps of receiving claim records and creating payment records are interchangeable.

Continuing with principal reference to FIGS. 6a and 6b, an embodiment of a scanning user-operable interface is shown and designated generally as 700. Scanning interface 700 allows a user to customize the parameters of the scan. The user may select a form type by using form-type drop-down menu 710, for example. Remittance documents may come in many different formats, depending in part on the company that has produced the document. Scanning module 120 has selectable access to data specific to a plurality of different form types. As shown in FIG. 5, the sample form is attributable to “FormCorp” and drop-down menu 710 would thus be used to select “FormCorp.” A user tags a scan for further reference by check amount and check number by entering information into check number field 720 and check amount field 740, respectively. A user indicates direct deposit by checking direct deposit box 730.

A user also defines the type of price codes that appear on remittance document 105. An insurance company may choose to list price codes instead of itemized amounts, where each price code represents an itemized amount. To the extent the remittance document 105 contains these price codes, a user may indicate the style of price coding into price code field 750. The user may additionally indicate whether the information itemized on remittance document 105 relate to payment records attributable to one or more “stores” (e.g. pharmacy, medical practice, dental practice, etc.). A user can indicate in checkboxes 760 whether payment is for one store or many, and can specify a specific store number for future reference.

A user enters information into field 770 to indicate what type of scanner is being used. Any suitable scanner may be used, so long as the resolution is high enough to allow for the extraction of electronic payment records. Field 770 preferably comprises a drop-down menu containing a list of predetermined scanners. The processes of scanning and creating payment records are then initiated at the direction of a user who presses “OK” button 780. Operation may be cancelled by pressing “Cancel” button 790.

Referring to FIG. 6c, an embodiment of an emulation of remittance document 105 is shown and designated generally 800. Emulation 800 ultimately has a layout substantially similar to the layout of remittance document 105. Sometimes however, the columns may not initially be located in the correct place due to irregularities in scanning speed, humidity differences between the time the document was printed and scanned, etc. The scanning module 120 presents editing tools 850 for modifying an intermediary scan into an emulation 800 of remittance document 105.

For example, the location of the prescription number column 810a, amount paid column 820, and date column 810c, may be moved from side-to-side by using the RX button 865, amount paid button 860, and date button 855, respectively. If such changes are made to emulation 800, then a rescan is subsequently initiated by pressing rescan button 870. Once a final emulation has been achieved to the satisfaction of the user, print button 875 prints a copy of emulation 820 and finalizes the scan. A user may then extract payment records from the emulation and initiate the matching process by pressing match button 630.

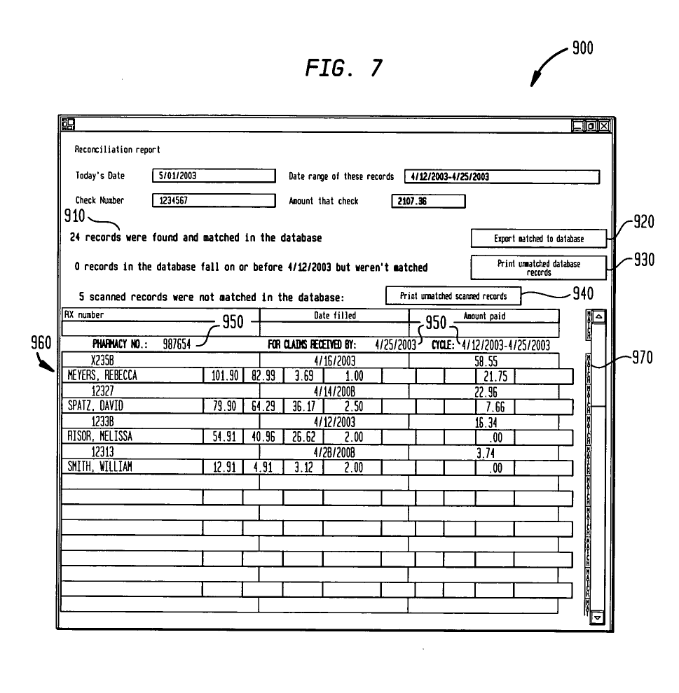

Referring to FIG. 7, an embodiment of a verification interface is shown and designated generally 900. Verification interface 900 preferably shows all information attributed with unmatched records. Verification interface 900 allows a user to control verification module 140 to forward reconciled records to external application 200, database 100b, export module 160, and/or database 310, to edit information and forward unreconciled records back to matching module 130 for re-matching.

Verification interface 900 has a header 910 containing various information about the current project. For example, header 910 articulates the current date, the date range of the records, the check number and amount, and the number of matched and/or non-matched. A user sends reconciled records by pressing send button 920. A user can print a report of unmatched claim records by pressing unmatched database records button 920. This in effect produces a report or otherwise indicates a list of missing payments. A user can also print a report of unmatched payment records by pressing unmatched scanned records button 930. This in effect produces a report or otherwise indicates a list of misdirected payments. As discussed below, a user can also edit information in an unmatched record and then send the record back to matching module 130 by pressing one of match buttons 970.

Verification interface 900 articulates the pharmacy number, the “claims received by” information, and the billing cycle information in fields 950. Depending upon the embodiment, this information may be entered manually and/or scanned from remittance form 105. Further, the information contained in field 950 is editable from verification interface 900.

As discussed above, verification interface 900 displays payment information where a match is unsuccessful. For example, referring to row 540 again, remittance scanning module 120 may incorrectly determined that Rebecca Myers is spelled “Rebecca Meyers” and/or that prescription number “12354” is really X235B. Field set 960 presents the user with scanned information giving the user a chance to edit the information and then send it back for another attempt at matching (e.g. re-matching). Field set 960 includes the payment value (e.g. $58.55) and at least one payment identification value (e.g. a specific prescription number). Field set 960 also contains other information corresponding to row 540, for example.

After field set 960 is edited the claim records and payment records are sent to matching module 130 for another attempt at matching. Should the record fail to match again, then the record will return to verification module 140. Again, the record will be editable in verification interface 900. Ultimately, the user will have control over whether an unmatched record will get flagged for further scrutiny or whether the record will be forwarded as reconciled to export module 160, database 100b, database 310, external application 200, etc.

Once all of the insurance claim records and payment records are reconciled, a pharmacy can then proceed by manual and/or automated means to share the documented reconciliation with the insurance company. The sharing of documented reconciliation records can be accomplished via a network, such as for example and without limitation, the Internet, VPN, or other connection. In this respect, the pharmacy can assist in the proper direction of misdirected payments and return of overpayments, while collecting missing payments and amounts due on underpayments.

Although there has been hereinabove described a system and method for reconciling an insurance payment, for the purposes of illustrating the manner in which the invention may be used to advantage, it should be appreciated that the invention is not limited thereto. Accordingly, any and all modifications, variations, or equivalent arrangements which may occur to one skilled in the art should be considered to be within the scope of the present invention as defined in the appended claims.

1. A method for reconciling an insurance payment to an entity, such as a pharmacy, with an insurance claim made by the entity, comprising:
providing a claim value belonging to a set of claim values;
providing a claim identification value associated with the claim value and belonging to a set of claim identification values;
providing a payment value belonging to a set of payment values;
providing a payment identification value associated with the payment value and belonging to a set of payment identification values; and
where the payment identification value and the claim identification value correspond to each other, matching the payment value with the claim value.

2. The method of claim 1, comprising:
where the payment value and the claim value are matched, comparing the payment value and the claim value to identify at least one of underpayment, overpayment, and accurate payment.

3. The method of claim 1, comprising:
indicating a missing payment, where the claim value is unmatched with each member of the set of payment values; and
indicating a misdirected payment, where the payment value is unmatched with each member of the set of claim values.

4. The method of claim 1, comprising forming a filter expression from a scan of a remittance document.

5. The method of claim 1, comprising scanning a remittance document that articulates a plurality of itemized payments and a plurality of itemized identifications, and that indicates an association between each of the plurality of itemized payment with at least one of the plurality of itemized identifications.

6. The method of claim 5, comprising defining the association between the payment value and the payment identification value based at least in part on the indicated associations.

7. The method of claim 6, comprising defining an association between another member of the set of payment values and another member of the set of payment identification values based at least in part on an association between another itemized payment and another itemized identification.

8. The method of claim 1, comprising verifying at least one of a match, an anomalous payment, an underpayment, an overpayment and an accurate payment.

9. The method of claim 5, comprising providing an emulation of the remittance document having an emulation layout substantially similar to a document layout of the remittance document.

10. The method of claim 1, wherein the claim identification value and the payment identification value each comprises a data item representative of at least one of a pharmacy customer, a prescription number, a date, a price code, a sale number, a social security number and a sale quantity.

11. The method of claim 10, comprising corresponding the payment value and the claim value with each other when the data items of associated claim identification values and payment identification values are the same.

12. The method of claim 10, comprising corresponding the payment value and the claim value with each other when the data items of associated claim identification values and payment identification values are related.

13. The method of claim 1, comprising importing at least one of the claim value and the claim identification value from an external application while maintaining the association between the claim value and the claim identification value.

14. The method of claim 13, comprising exporting the claim value and the payment value to the external application, while maintaining a relationship between the claim value and the payment value.

15. The method of claim 13, comprising posting the payment value to the external application, while maintaining a relationship between the claim value and the payment value.

16. The method of claim 1, comprising receiving at least one of the claim value and the claim identification value from a database, while maintaining the association between the claim value and the second identification value.

17. The method of claim 16, comprising sending the claim value and the payment value to the database, while maintaining a relationship between the claim value and the payment value.

18. The method of claim 16, comprising posting the payment value, while maintaining a relationship between the claim value and the payment value.

19. A method for reconciling an insurance payment to an entity, such as a pharmacy, with an insurance claim made by the entity, comprising:
providing a claim value belonging to a set of claim values; providing a claim identification value associated with the claim value and belonging to a set of claim identification values;
scanning a remittance document that articulates a plurality of itemized payments and a plurality of itemized identifications and associates an itemized payment with an itemized identification;
defining an association between a payment value and a payment identification value based at least in part on the association between the itemized payment and the itemized identification;
providing the payment value and the payment identification value;
where the payment identification value and the claim identification value correspond to each other, matching the payment value with the claim value;
where the payment value is unmatched with each member of the set of claim values, indicating a misdirected payment; and
where the claim value is unmatched with each member of the set of payment values, indicating a missing payment.

20. The method of claim 19, comprising forming a filter expression from the scan.

21. The method of claim 19, comprising defining an association between another payment value and another payment identification value based at least in part on an association between another itemized payment and another itemized identification.

22. The method of claim 19, comprising verifying at least one of an underpayment, an overpayment and an accurate payment.

23. The method of claim 19, comprising providing an emulation of the remittance document having an emulation layout substantially similar to a document layout of the remittance document.

24. The method of claim 19, wherein at least one of the claim identification value and the payment identification value comprise a data item representative of at least one of a pharmacy customer, a prescription number, a date, a price code, a sale number, a social security number and a sale quantity.

25. The method of claim 24, comprising corresponding the payment value and the claim value with each other when the data items of associated claim identification values and payment identification values are the same.

26. The method of claim 24, comprising corresponding the payment value and the claim value with each other when the data items of associated claim identification values and payment identification values are related.

27. The method of claim 19, comprising importing at least one of the claim value and the claim identification value from an external application while maintaining the association between the claim value and the claim identification value.

28. The method of claim 27, comprising exporting the payment value to the external application, while maintaining a relationship between the claim value and the payment value.

29. The method of claim 27, comprising posting the payment value to the external application, while maintaining a relationship between the claim value and the payment value.

30. The method of claim 19, comprising receiving at least one of the claim value and the claim identification value from a database, while maintaining the association between the claim value and the claim identification value.

31. The method of claim 19, comprising sending the payment value to the database, while maintaining a relationship between the claim value and the payment value.

32. The method of claim 19, comprising posting the payment value, while maintaining a relationship between the claim value and the payment value.

33. A system for reconciling an insurance payment to an entity, such as a pharmacy, with an insurance claim made by the entity, comprising a computer-readable medium having stored thereon computer-executable instructions for performing the following:
providing a claim value belonging to a set of claim values;
providing a claim identification value associated with the claim value and belonging to a set of claim identification values;
providing a payment value belonging to a set of payment values;
providing a payment identification value associated with the payment value and belonging to a set of payment identification values; and
where the payment identification value and the claim identification value correspond to each other, matching the payment value with the claim value.

34. The system of claim 33, wherein the computer-readable medium has stored thereon computer-executable instructions for performing the following:
where the payment value is unmatched with each member of the set of claim values, indicating an anomalous payment.

35. The system of claim 33, wherein the computer-readable medium has stored thereon computer-executable instructions for performing the following:
where the claim value is unmatched with each member of the set of payment values, indicating a missing payment.

36. The system of claim 33, wherein the computer-readable medium has stored thereon computer-executable instructions for forming a filter expression from a scan of an itemized remittance document.

37. The system of claim 33, wherein the computer-readable medium has stored thereon computer-executable instructions for scanning a remittance document that articulates a plurality of itemized payments and a plurality of itemized identifications and associates an itemized payment with an itemized identification.

38. The system of claim 37, comprising a scanner.

39. The system of claim 37, wherein the computer-readable medium has stored thereon computer-executable instructions for defining the association between the payment value and the payment identification value based at least in part on the association between the itemized payment and the itemized identification.

40. The system of claim 37, wherein the computer-readable medium has stored thereon computer-executable instructions for defining an association between another member of the set of payment values and another member of the set of payment identification values based at least in part on an association between another itemized payment and another itemized identification.

41. The system of claim 35, wherein the computer-readable medium has stored thereon computer-executable instructions for verifying at least one of a match, an anomalous payment, an underpayment, an overpayment and an accurate payment by, where the payment value and the claim value are matched, comparing the payment value and the claim value to identify at least one of underpayment, overpayment, and accurate payment.

42. The system of claim 41, wherein the computer-readable medium has stored thereon computer-executable instructions for providing a printed emulation of the remittance document having an emulation layout substantially similar to a document layout of the remittance document.

43. The system of claim 42 comprising a printer.

44. The system of claim 33, wherein the claim identification value and the payment identification value each comprises a data item representative of at least one of a pharmacy customer, a prescription number, a date, a price code, a sale number, a social security number and a sale quantity.

45. The system of claim 44, wherein the computer-readable medium has stored thereon computer-executable instructions for corresponding the payment value and the claim value with each other when the data items of associated claim identification values and payment identification values are the same.

46. The system of claim 44, wherein the computer-readable medium has stored thereon computer-executable instructions for corresponding the payment value and the claim value with each other when the data items of associated claim identification values and payment identification values are related.

47. The system of claim 33, wherein the computer-readable medium has stored thereon computer-executable instructions for importing at least one of the claim value and the claim identification value from an external application while maintaining the association between the claim value and the claim identification value.

48. The system of claim 47, wherein the computer-readable medium has stored thereon computer-executable instructions for exporting the payment value to the external application, while maintaining a relationship between the claim value and the payment value.

49. The system of claim 47, wherein the computer-readable medium has stored thereon computer-executable instructions for posting the payment value to the external application, while maintaining a relationship between the claim value and the payment value.

50. The system of claim 47, comprising the external application.

51. The system of claim 33, wherein the computer-readable medium has stored thereon computer-executable instructions for receiving at least one of the claim value and the claim identification value from a database, while maintaining a relationship between the claim value and the payment value.

52. The system of claim 51, wherein the computer-readable medium has stored thereon computer-executable instructions for sending the payment value to the database, while maintaining a relationship between the claim value and the payment value.

53. The system of claim 51, wherein the computer-readable medium has stored thereon computer-executable instructions for posting the payment value to the database, while maintaining a relationship between the claim value and the payment value.

54. The system of claim 51, comprising the database.

55. The system of claim 33, comprising a processor for executing the instructions.

56. A method for reconciling insurance payments with insurance claims, comprising:
receiving a plurality of unpaid claim records;
creating a plurality of payment records from a scanned remittance document; and
matching at least one of the plurality of unpaid claim records with a corresponding one of the plurality of payment records to form a reconciled claim record.

57. The method of claim 56, comprising scanning the remittance document.

58. The method of claim 56, comprising comparing the at least one unpaid claim record against a corresponding one of the payment records to identify one of an underpayment, an overpayment, and an accurate payment.

59. The method of claim 58, comprising indicating the one of the underpayment, the overpayment and the accurate payment.

60. The method of claim 56, comprising verifying the accuracy of information making-up the reconciled claim record.

61. The method of claim 56, wherein receiving comprises receiving from an external application

62. The method of claim 61, comprising exporting the reconciled claim record to an external application, and wherein receiving comprises importing the unpaid claim record from the external application.

63. The method of claim 61, wherein receiving comprises receiving the plurality of unpaid claim records from a database, and indicating comprises sending a plurality of reconciled claim records to the database.
